(19) United States
(12) Patent Application Publication
(10) Pub. No.: US 2007/0176910 A1
(43) Pub. Date: Aug. 2, 2007

(54) Systems and methods for navigating a mobile communication device menu

(76) Inventors: Mark Simek, San Diego, CA (US); James Pieronek, San Diego, CA (US); Richard La Spesa, Santee, CA (US)

Correspondence Address: KYOCERA WIRELESS CORP., P.O. BOX 928289, SAN DIEGO, CA, 92192-8289, US

(21) Appl. No.: 11/341,063

(22) Filed: Jan. 27, 2006

(51) Int. Cl. G09G 5/00

(52) U.S. Cl. 345/184

(57) ABSTRACT

A mobile communication device comprising a rotary input device, wherein the rotary input device comprises an optical sensor configured to sense rotation of the rotary input device and a processor coupled to the rotary input device configured to process input from the rotary input device. The rotary input device can, in an embodiment provide rotation inputs and keypad inputs.

### FIELD OF THE INVENTIONS

The field of the invention relates generally to mobile communication devices and more particularly to user input devices on mobile communication devices.

### BACKGROUND INFORMATION

Many mobile communication devices, such as mobile telephone handsets, include a large number of features. In some cases, each feature may be accessed through a menu structure. For example, a top level menu in the menu structure can include items, such as contact lists, lists of recent calls, settings, and tools, to name a few. Each top level menu item may include lower level menu items below it. For example, a tools menu can include a calendar, alarm clock, calculator, etc. As the size and complexity of the menu structure grows it can become increasingly difficult to navigate the menu structure.

Using keypad inputs to scroll through the long menu structure can be tedious. For example, it may be necessary to depress a key each time a user wants to scroll up, down, left, or right one entry within the menu. Alternatively, holding a key down for a period of time can, in some devices, scroll through multiple entries within a menu; however, the user's ability to control scrolling speed through the list may be limited. For example, continuously depressing a key on a keyboard or other input device can cause some devices to scroll through entries in a menu at a fixed, predetermined speed. Alternatively, a rotary input device can be a convenient way to navigate these long menu structures, since the rotary input can provide the user some control over how fast to scroll. For example, the faster the user spins the rotary input device, the faster the mobile communication device scrolls through the menu list.

Mechanical rotary input devices have been used on electronic devices, such as mobile communication devices; however, mechanical rotary input devices have several disadvantages. For example, mechanical rotary input devices can be relatively costly, can have a relatively low mean time between failures, and can be difficult to incorporate into a surface mount design, since many of the devices not surface mount.

### SUMMARY OF THE INVENTION

A mobile communication device comprising an optical rotary input device, wherein the optical rotary input device comprises an optical sensor configured to sense rotation of the optical rotary input device and a processor coupled to the optical rotary input device configured to process input from the optical rotary input device. The optical rotary input device can, in an embodiment provide rotation inputs and keypad inputs.

Other features and advantages of the present invention will become more readily apparent to those of ordinary skill in the art after reviewing the following detailed description and accompanying drawings.

### BRIEF DESCRIPTION OF THE DRAWINGS

FIGS. 1A-1D are diagrams illustrating the clockwise operation of a optical rotary input device in accordance with one embodiment.

FIGS. 2A-2D are diagrams illustrating the counterclockwise operation of an optical rotary input device in accordance with one embodiment.

FIG. 3 is a diagram summarizing the operations discussed with respect to FIGS. 1 and 2.

FIG. 4 is a diagram illustrating an example implementation of an optical rotary device in accordance with one embodiment.

FIG. 5 is a circuit diagram illustrating the optical rotary input device described with respect to FIG. 4.

FIG. 6 is a diagram illustrating the operation of an optical rotary input device in accordance with another embodiment.

FIG. 7 is a flow chart illustrating an example method for incorporating an optical rotary input device on a mobile communication device in accordance with one embodiment.

FIGS. 8A-8B are diagrams illustrating the operation of an embodiment of an optical rotary input device in accordance with the systems and methods described herein in accordance with one embodiment.

FIG. 9 is a diagram illustrating a mobile communication device that incorporates an optical rotary input device in accordance with one embodiment.

### DETAILED DESCRIPTION

An optical rotary device configured in accordance with the systems and methods described herein can, in some cases, provide many advantages for use in a mobile communication device. For example, an optical rotary device as described herein can provide a convenient way to navigate long lists within a menu structure. In other words, an optical rotary device as described herein can, in some cases, lead to easier scrolling through the menu structure. Optical rotary devices as described herein can, in some cases, last longer than mechanical rotary devices, since optical rotary device as described herein typically have a reduced number of moving contacts. In other words, an optical rotary device has moving parts moving parts, but fewer moving parts than a mechanical rotary device.

The operation of several example implementations of optical rotary devices configured in accordance with the systems and methods describe herein will be discussed further below. An optical rotary device configured in accordance with the systems and methods described herein can be surface mount and, therefore, in many cases can be more easily incorporated into surface mount boards. Additionally, optical rotary devices configured in accordance with the systems and methods described herein can help lower costs.

Optical rotary devices as described herein can have one drawback with regard to mobile communication device, such as mobile telephone handsets, in that such optical rotary devices require a light source. The light source, commonly a light emitting diode (LED), consumes power. Power consumption can be a significant concern when designing mobile communication devices. Mobile communication devices are, in many cases, small, battery powered devices. It is generally desirable to the users of such devices that the devices operate for long periods of time on a single set of batteries, and/or a single battery charge. In order to increase the time between charges and/or battery changes, it can be advantageous to decrease power consumption. Fortunately, a mobile communication device is used relatively sparingly. Thus, an optical rotary device as described herein is not being used much of the time when incorporated into a mobile communication device and, therefore, the power drain caused by the light source, such as an LED, will generally have little negative impact.

Accordingly, some of the systems and methods described below are directed to ways to reduce the power consumption of an optical rotary device configured in accordance with the systems and methods described herein by disabling the optical rotary input device for certain periods and/or at certain times.

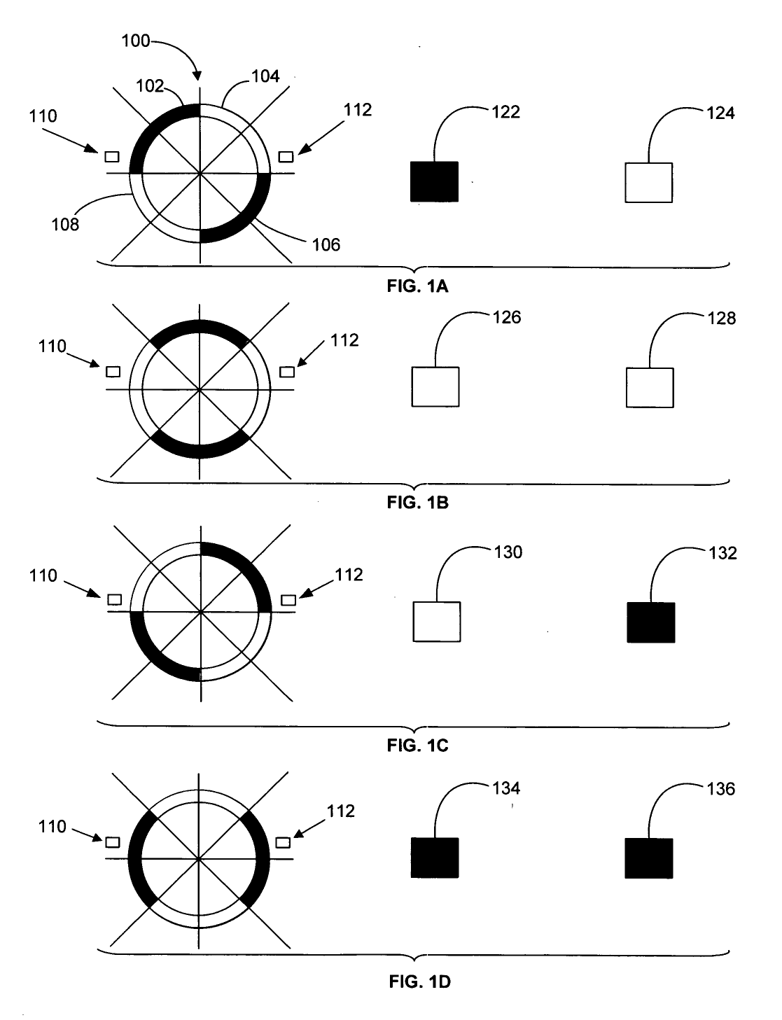

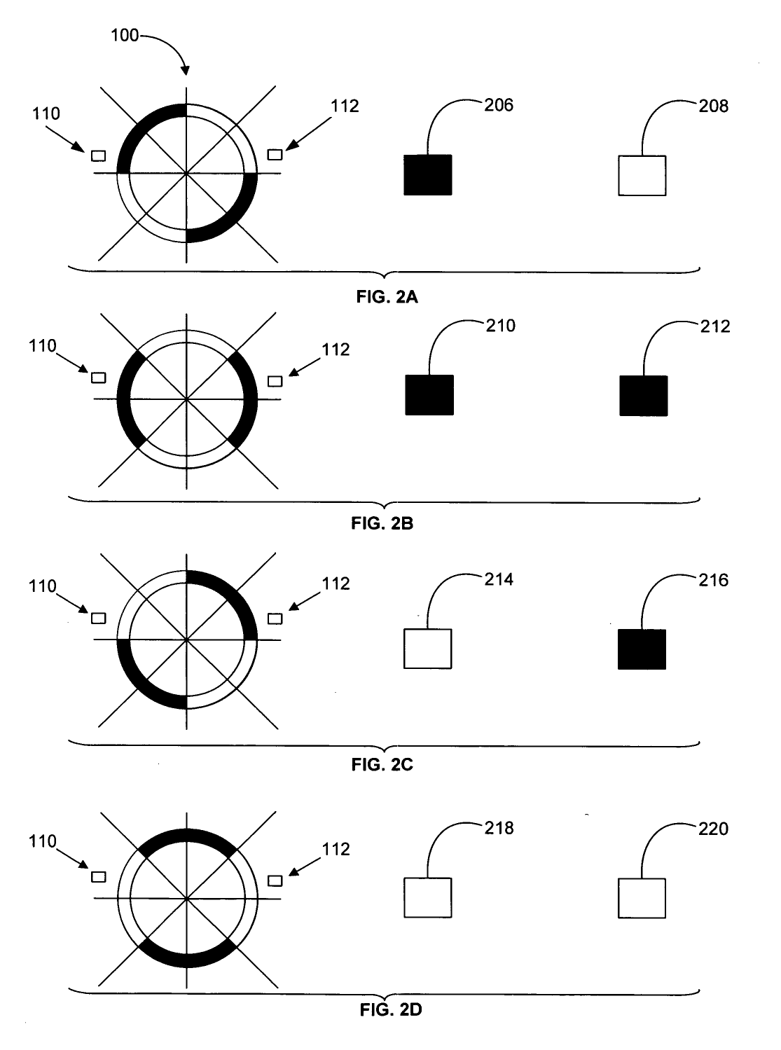

FIGS. 1A-1D are diagrams illustrating the operation of an optical rotary input device in accordance with one embodiment of the systems and methods described herein. The diagrams illustrate clockwise rotation of an optical rotary wheel 100 through half of one rotation, e.g., 180 degrees. After 180 degrees of rotation the pattern produced repeats, assuming that rotation continues. Counterclockwise rotation will be discussed with respect to FIGS. 2A-2D.

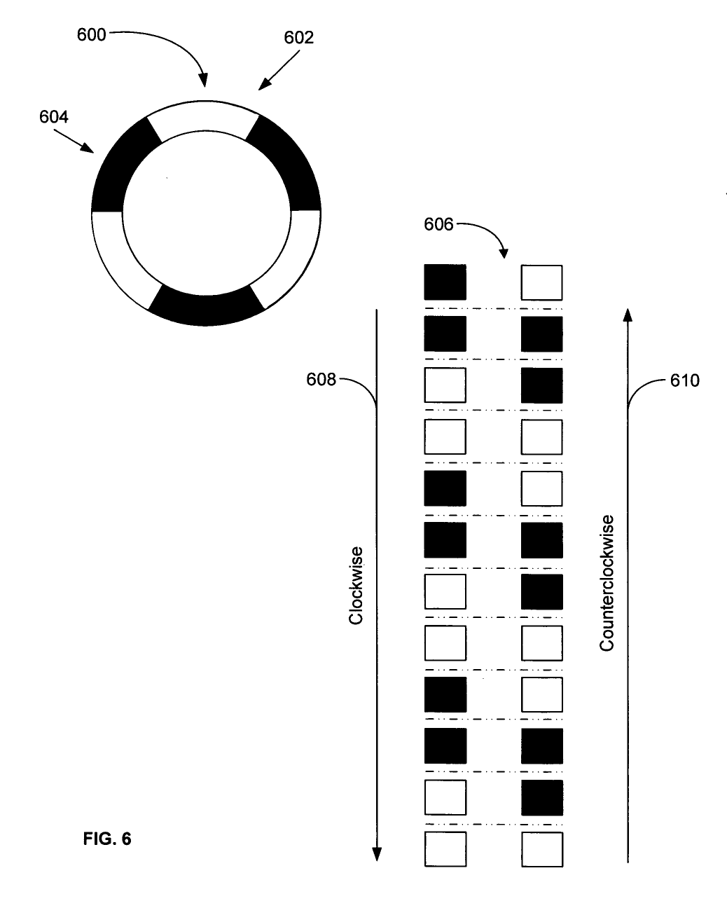

Wheel 100 can be divided into four sections 102, 104, 106, 108. Fewer or greater divisions are possible. For example, FIG. 6 illustrates a wheel that is divided into 6 sections. Generally, smaller angular movements can be detected by using a greater number of divisions. Sections 102, 104, 106, 108 can, for example, each represent a 90 degrees portion of wheel 100. In the example illustrated, two portions 102 and 106 are dark and two portions 104 and 108 are light. Sensors 110 and 112 can be positioned to sense rotation of wheel 100 and can be used to detect the dark and light portions of wheel 100. For example, wheel 100 can begin in the position illustrated in FIG. 1A, where sensor 110 is pointed at a dark portion as indicated by box 122 and sensor 112 is pointed at a light portion as indicated by box 124, i.e., boxes 122 and 124 are used to illustrate the state of the input of sensors 110 and 112.

When wheel 100 is turned clockwise 45 degrees to the position illustrated in FIG. 1B, sensor 110 is pointed at a light portion as indicated by box 126 and sensor 112 is pointed at a light portion as indicated by box 128. It should be noted that while each of the sections 102, 104, 106, 108 can be a 90 degree portion of wheel 100 sensors 110 and 112 can be configured to detect rotation in increments of less than 90 degrees, such as in 45 degree increments. In other words, wheel 100 can be used to measure rotation in increments that are less than the full increment represented by the portions making up wheel 100.

Wheel 100 can continue to be rotated in 45 degree increments. Thus, wheel 100 will eventually arrive in the positions illustrated by FIGS. 1C and 1D. In the position illustrated in FIG. 1C, sensor 110 is pointed at a light portion as indicated by box 130 and sensor 112 is pointed at a dark portion as indicated by box 132. In the position illustrated in FIG. 1D, sensor 110 is pointed at a dark portion as indicated by box 134 and sensor 112 is also pointed at a dark portion as indicated by box 136.

Between the position illustrated in FIG. 1A and the position illustrated in FIG. 1D, wheel 100 rotates 180 degrees. As discussed above, the pattern illustrated by boxes 122, 124, 126, 128, 130, 132, 134, 136 can then repeat if wheel 100 continues to be rotated in a clockwise direction. For example, if wheel 100 is rotated another 45 degrees in a clockwise direction the new pattern will correspond to the position of FIG. 1A, i.e., boxes 122 and 124, but the dark and light portions 120, 104, 106, 108 will each be swapped with each other, i.e., dark portion 102 swapped with dark portion 106, and light portion 104 swapped with light portion 108.

FIGS. 2A-2D are diagrams illustrating the operation of the optical rotary input device of FIGS. 1A-1D rotating counterclockwise in accordance with one embodiment of the systems and methods described herein. Wheel 100 begins in the positon illustrated in FIG. 2A, where sensor 110 is pointed at a dark portion as indicated by box 206 and sensor 112 is pointed at a light portion as indicated by box 208. Wheel 100 can then be rotated 45 degrees counterclockwise to the position illustrated in FIG. 2B, where sensor 110 is pointed at a dark portion as indicated by box 210 and sensor 112 is also pointed at a dark portion as indicated by box 212. Wheel 100 can then be rotated another 45 degrees counterclockwise to the position illustrated by FIG. 2C, where sensor 110 is pointed at a light portion as indicated by box 214 and sensor 112 is pointed at a dark portion as indicated by box 216. Completing a 180 degree turn to the position illustrated by FIG. 2D with one more 45 degree rotation, sensor 110 is pointed at a light portion as indicated by box 218 and sensor 112 is also pointed at a light portion as indicated by box 220. Similarly to the description with respect to FIGS. 1A-1D, the pattern illustrated by boxes 206, 208, 210, 212, 214, 216, 218, 220 repeats if wheel 100 continues to rotated in a counterclockwise direction.

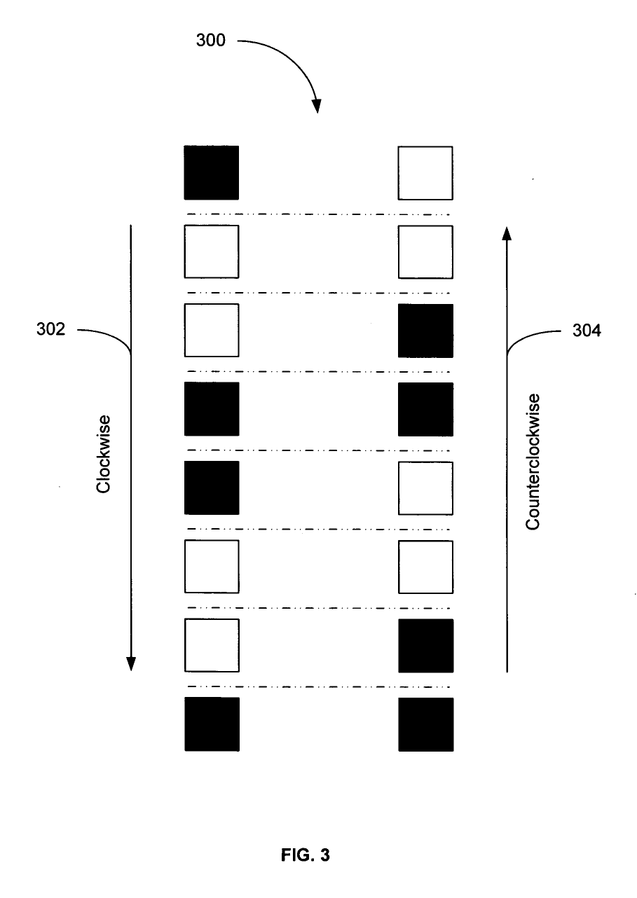

FIG. 3 is a diagram illustrating the pattern of operation of an optical rotary device, rotating clockwise through 360 degrees and counterclockwise through 360 degrees. The diagram includes boxes 300 that illustrate the patterns produced by sensors 110 and 112 as wheel 100 is rotated clockwise and counterclockwise. An arrow 302 indicates clockwise rotation and another arrow 304 indicates counterclockwise rotation. In other words, working downward, arrow 302, the boxes change following the pattern of FIGS. 1A-1D, while working upwards, arrow 304, the boxes follow the pattern of FIGS. 2A-2D. The rotary input device can begin in any of the boxes, depending on the position the device is left in after the last rotation, or the initial position when the device is manufactured. Additionally, the device can change direction as a user rotates the device, for example, to navigate a user interface menu structure in a mobile communication device.

FIG. 6 is a diagram illustrating a portion of an optical rotary input device in accordance with another embodiment of the systems and methods described herein. The diagram is similar to the diagrams discussed with respect to FIGS. 1-3, however, the wheel 602 of FIG. 6 includes 3 light portions and 3 dark portions instead of 2 of each. The optical rotary input device can include an optically readable portion 600. The alternating dark and light sections can be read by a pair of sensors 602 and 604. The optical rotary input device in this example can have twelve discrete positions as the input device is turned 360 degrees. By determining the light and dark readings from each of these twelve positions using sensors 602 and 604 movement and direction can be determined.

Similar to FIG. 3 a series of pairs of square boxes 606 are shown to illustrate possible reading from the sensors 602 and 604. Arrows 608 and 610 indicate clockwise and counterclockwise rotation. The embodiment described with respect to FIG. 6 has six different portions, each portion is 60 degrees. By using 60 degree portions the rotary input device can measure in increments of 30 degrees. As can be seen from the diagram, the pattern repeats three times while completing one 360 degree turn of the optical rotary input device. Similar to FIGS. 1-3, the rotary input device of FIG. 6 can determine turning direction and angular distance turned.

Thus, a user can navigate through menus on a screen using an optical rotary device as described above. Changes in the patterns tell the device to move to the next item, or several items, and in what direction. The pattern does not need to start at any particular place in the pattern, because once the device knows what the current pattern is, it knows what the next pattern should be for clockwise and counterclockwise rotation. Thus, by assigning each direction of rotation to a particular direction, i.e., up, down, left, or right, the device can determine, e.g., whether to go up, down, or sideways, in a menu based on the next pattern to emerge.

An optical rotary wheel conFigured as described herein can also be used to make a selection, e.g., of a menu item. For example, in embodiments described below, buttons or push button domes can be included on the wheel portion that can be depressed to make a selection or entry and/or contacts can be included under the wheel such that pressing the wheel down will cause a contact to be engaged. Again, embodiments that include buttons, domes, and contacts are described in more detail below.

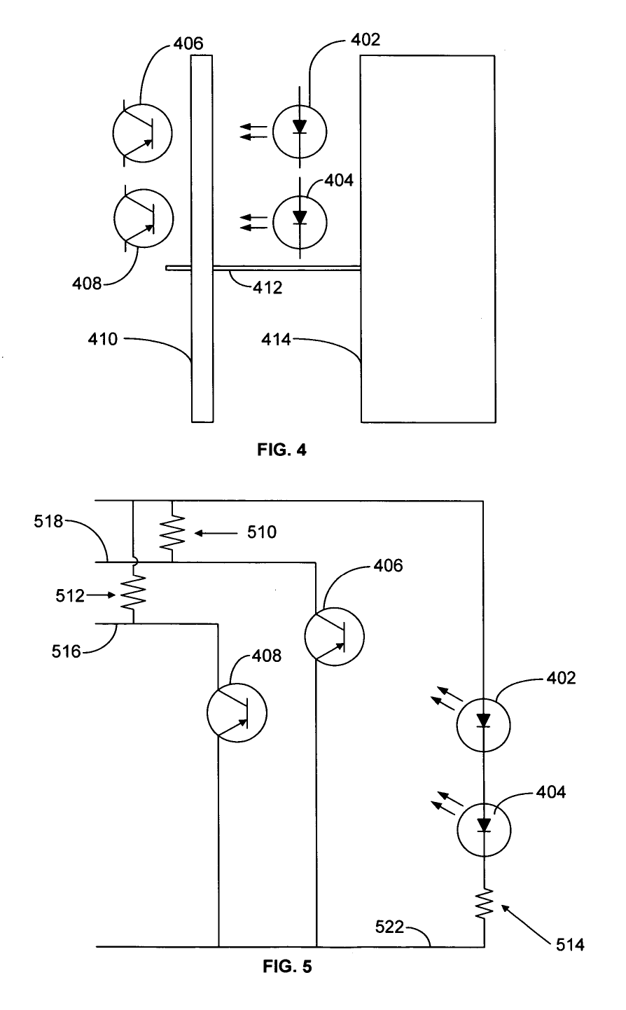

As described above with respect to FIGS. 1-3 sensors 110 and 112 can be configured to detect whether a light position or a dark position of wheel 100 is in front of, or over the sensor. FIGS. 4 and 5 illustrate specific implementations of an optical rotary device configured to operate, e.g., as illustrated in FIGS. 1 and 2.

FIG. 4 is a diagram illustrating an embodiment that uses a combination of light emitting diodes (LEDs) 402 and 404 and transistors 406 and 408 to measure rotation. A wheel 410 can be placed between LEDs 402 and 404 and transistors 406 and 408. Wheel 410 can have some number of openings that allow light from LEDs 402 and 404 to illuminate transistors 406 and 408. For example, wheel 410 of FIG. 4 can be similar to wheel 100 of FIGS. 1 and 2, wherein each light area 104 and 108 can represent an opening on wheel 410 and each dark area 102 and 108 can represent an area that does not have an opening. Wheel 410 can be connected to a knob 412 by a shaft 414. As knob 414 is turned transistors 406 and 408 are illuminated in a pattern similar to the patterns described with respect to FIGS. 1-3. The pattern of transistor 406 and 408 illumination can then be used to determine rotation of knob 414. FIG. 4 illustrates an embodiment that includes LEDs 402 and 404 as an illumination source, however, other illumination sources are possible, e.g., lamps, etc.

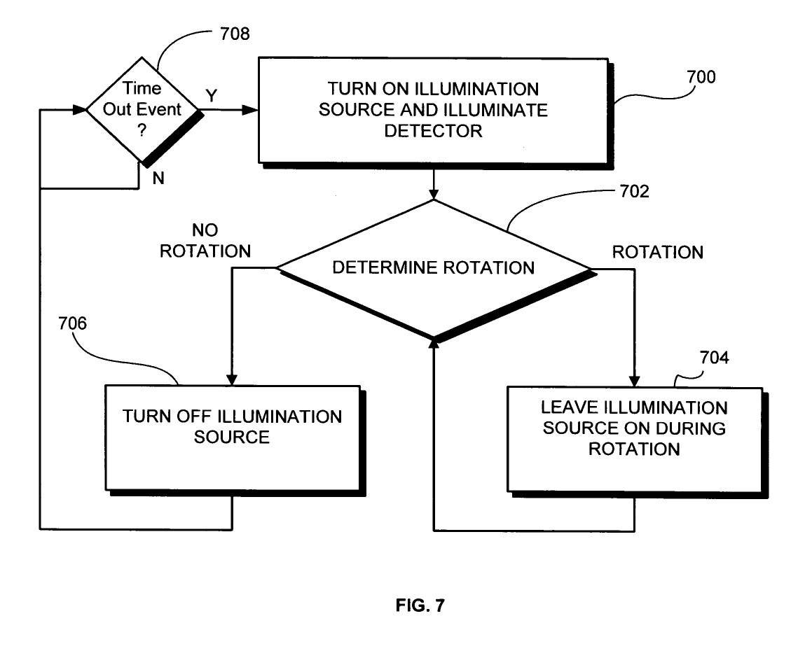

FIG. 5 is a circuit diagram that can be used in an embodiment that uses LEDs 402 and 404 and transistors 406 and 408 of FIG. 4. LEDs 402 and 404 can be connected between power and ground through a resistor 414 and can illuminate transistors 406 and 408 when power is applied, depending on the position of wheel 410 as described in FIG. 4. In one embodiment power can be turned on and off at various time to save battery power, as described below with respect to FIG. 7.

Each of transistors 406 and 408 operate as switches. When such a transistor is not illuminated it is like the switch is off, and when such a transistor is illuminated it is like the switch is on. When transistor 406 or 408 is illuminated the corresponding output 516 or 518 is connected through the transistor to ground 522, causing the output to be a low voltage. Alternatively, when a transistor 406 or 408 is not illuminated the output 516 or 518 is pulled high by resistor 410 or 412, causing the output to be a high voltage. It should be noted that this is a simplification. Transistors 406 and 408 are not exactly like switches. For example, when a transistor 406 or 408 is “off,” it may still allow some amount of current to flow; however, the amount of current is generally much smaller than when the transistor is “on.” The operation of transistors 406 and 408 is well known and in the interest of brevity will not be discussed further herein.

As mentioned, incorporating an optical rotary device as described herein can reduce the number of moving parts, which can lead to lower costs and a longer mean time between failure. Further, an optical rotary device configured in accordance with the system sand methods described herein can be a surface mount device, allowing for easier incorporation into surface mount designs. But the light source, or sources, such as LEDs 402 and 404, can increase power consumption and reduce battery life. Therefore, in some embodiments, it can be preferable to implement methods for reducing the power consumption associated with the optical rotary device configured in accordance with the systems and methods described herein.

FIG. 7 is a flow chart illustrating an example method for reducing the power consumption of an optical rotary input device in accordance with one embodiment of the systems and methods described herein. In step 700, an illumination source can be turned on, illuminating a detector associated with an optical rotary device. The illumination source can be an LED, as described with respect to FIGS. 4-5. In step 702, it is determined whether the optical rotary device is rotating. If the device is not rotating, then power to the device can be removed for some period of time in step 706. If the device is rotating, then the illumination source can be left on until the rotation is complete in step 704.

In other words, a device incorporating and optical rotary device as described herein can be configured to detect whether the device is active and if not, then turn of power to the device to lower power consumption. Power can be turned off for a predetermined period of time. For example, power can be periodically applied to the optical rotary device to illuminate the detector (step 700) and determine whether there is rotation (step 702). Alternatively, certain activity, such as an incoming call or key press, or a certain state or state transition, such as transitioning from a sleep to an active state, can cause the illumination source to be activated. Thus, in step 708, it can be determined whether it is time to activate the illumination source.

As an example, assume that an LED used as an illuminating device in a optical rotary input device consumes 20 mA when it is on. Further, assume that a particular mobile communication device has a 1000 mAh battery. In other words, the battery can provide 1000 mA for 1 hour. If the LED is continuously on the battery would be discharged after about 50 hours, not considering any other circuit that the battery may be powering. Since the battery generally would have to power other circuitry it is likely that the battery in a mobile communication device would be discharged in much less than 50 hours. Alternatively, assume that the LED is on for 0.1 ms every 25 ms, for example, 0.4% of the time, now the 1000 mAh battery can power the LED for about 12,500 hours, not considering any other circuitry, saving power and potentially increasing “standby” and “talk” time of, for example, a mobile telephone handset.

As a further example, some mobile communication devices include a “sleep” mode. Generally, “sleep” mode uses less power than other operating modes. The mobile communication device may, for example, go into “sleep” mode when the phone has not been used to send or receive a communication for a predetermined time period. It can be determined that the mobile communication device is in “sleep” mode. In an embodiment, the light source in the optical rotary input device can be turned off during “sleep” mode and can be left off as long as the mobile communication device remains in sleep mode, in this way, power consumption due to the LED can be further decreased.

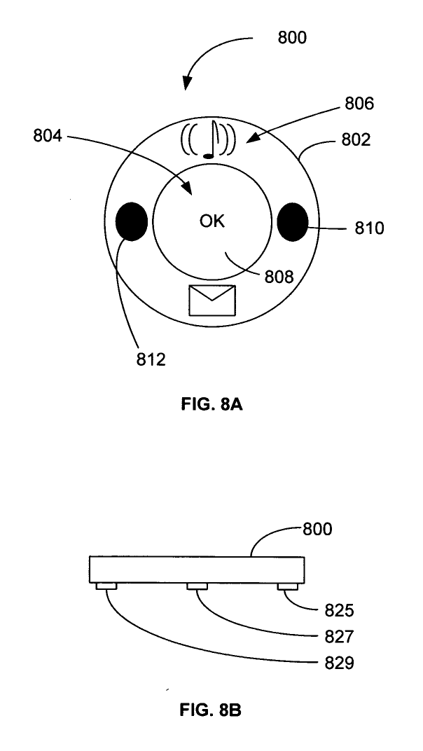

FIGS. 8A-8B are diagrams illustrating an optical rotary input device 802 in accordance with one embodiment of the systems and methods described herein. FIG. 8A illustrates an optical rotary device 802 that can include rotational inputs and inputs from button depression. A central button 804 can provide an input to a device using optical rotary input device 802, e.g., “OK” can be used to select an item in a menu. Additional keys, such as keys 806, 808, 810, 812 can also be included. The keys 806, 808 can include a picture to indicate a function. For example, key 806 can be used to turn a ringer on and off or key 808 can be used to access voice mail. It may be useful to have multiple functions, even on keys 806 and 808. Keys 810 and 812 are shown as generic, but specific functions can be assigned and in another embodiment the keys can include a picture indicating the assigned function.

Buttons, or domes, can be built into the optical rotary input device, as shown with respect to FIG. 8A. Alternatively, the optical rotary input device can be mounted such that the device can be depressed to activate contacts 825, 827, 829 located below optical rotary input device 802 as illustrated in FIG. 8B

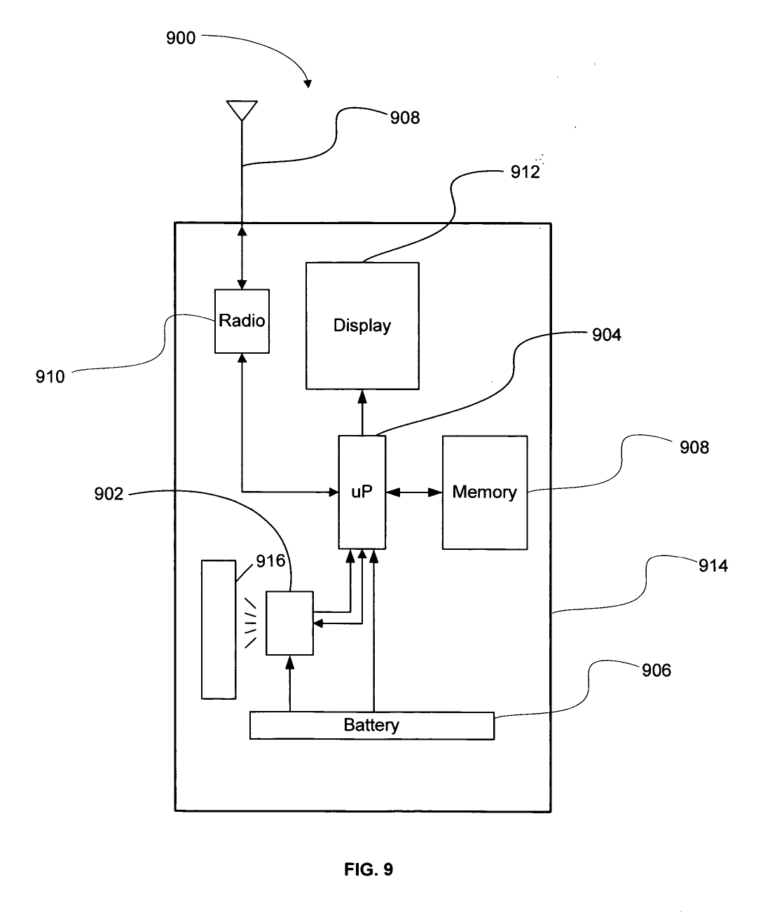

FIG. 9 is a diagram illustrating a mobile communication device 900 in accordance with one embodiment of the systems and methods described herein. Mobile communication device 900 can include an antenna 908 for sending and receiving communication signals from a radio 910. Radio 910 can be coupled to a processor 904. Processor 904 can be a microprocessor, digital signal processor, digital logic, or some combination of these device.

Processor 904 can be coupled to a memory 908, for example, a FLASH memory for storing instructions executed by the processor to perform the functions of the mobile communication device. Processor 904 can be coupled to a display 912 for providing information to the user of mobile communication device 200.

A battery 906 can be coupled to processor 904 and can provide power to processor 904. Additionally, battery 906 can be coupled to a light source 902. Light source 902 can be, for example, a light emitting diode (LED). Light source 902 can provide light to an optical rotary input device 916.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A mobile communication device comprising:
an optical rotary device comprising an optical sensor configured to sense rotation of the optical rotary device; and
a processor coupled to the optical rotary device, the processor configured to determine whether the optical rotary device is rotating via the optical sensor and remove power from the optical rotary device when it is determined that the rotary device is not rotating.

2. The mobile communication device of claim 1, wherein the processor is further configured to determine an input based on the rotation of the optical rotary device when it is determined that the optical rotary device is rotating.

3. The mobile communication device of claim 1, wherein the processor is further configured to determine if a time period has elapsed and, and to apply power to the optical rotary device when the time period has elapsed.

4. The mobile communication device of claim 1, wherein the processor is further configured to determine if the mobile communication device is in a sleep mode, and to apply power to the optical rotary device when it is determined that the mobile communication device is not in sleep mode.

5. The mobile communication device of claim 1, wherein the optical rotary device further comprises a push button dome configured to provide an input to the processor.

6. The mobile communication device of claim 1, wherein the optical rotary device further comprises a plurality of push button domes, wherein each of the plurality of push button domes is configured to provide a plurality of inputs to the processor.

7. The mobile communication device of claim 1, wherein the optical sensor further comprises a light source.

8. The mobile communication device of claim 7, wherein the light source comprises a light emitting diode.

9. The mobile communication device of claim 7, wherein removing power form the optical rotary device comprise removing power form the light source.

10. The mobile communication device of claim 1, wherein the optical rotary input comprises four alternating light and dark portions each representing a 90 degree rotation, and wherein the optical sensor is configured to sense a degree of rotation that is less than 90 degrees.

11. The mobile communication device of claim 1, wherein the optical sensor is configured to sense rotation in 45 degree increments.

11. The mobile communication device of claim 1, wherein the optical rotary input comprises six alternating light and dark portions each representing a 60 degree rotation, and wherein the optical sensor is configured to sense a degree of rotation that is less than 60 degrees.

12. The mobile communication device of claim 11, wherein the optical sensor is configured to sense rotation in 30 degree increments.

13. The mobile communication device of claim 1, wherein the optical sensor is configured to detect clockwise and counterclockwise rotation.

14. The mobile communication device of claim 1, further comprising a plurality of optical sensor configured to detect rotation of the rotary input device.

15. A method for conserving power in a device that includes an optical rotary device, comprising:
determining whether the optical rotary device is rotating via the optical sensor; and
removing power from the optical rotary device when it is determined that the rotary device is not rotating.

16. The method of claim 15, further comprising determining an input based on the rotation of the optical rotary device when it is determined that the optical rotary device is rotating.

17. The method of claim 16, further comprising determining if a time period has elapsed and, and applying power to the optical rotary device when the time period has elapsed.

18. The method of claim 15, further comprising determining if the mobile communication device is in a sleep mode, and applying power to the optical rotary device when it is determined that the mobile communication device is not in sleep mode.
